(19) United States
(12) Patent Application Publication
(10) Pub. No.: US 2023/0075893 A1
(43) Pub. Date: Mar. 9, 2023

(54) SPEECH RECOGNITION MODEL STRUCTURE INCLUDING CONTEXT-DEPENDENT OPERATIONS INDEPENDENT OF FUTURE DATA

(71) Applicant: Tencent Technology (Shenzhen) Company Limited, Shenzhen (CN)

(72) Inventors: Dan SU, Shenzhen (CN); Liqiang HE, Shenzhen (CN)

(73) Assignee: Tencent Technology (Shenzhen) Company Limited, Shenzhen (CN)

(21) Appl. No.: 17/987,287

(22) Filed: Nov. 15, 2022

Related U.S. Application Data
(63) Continuation of application No. PCT/CN2022/070388, filed on Jan. 5, 2022.

(30) Foreign Application Priority Data
Jan. 12, 2021 (CN) 202110036471.8

(51) Int. Cl. G10L 15/16; G10L 15/02

(52) U.S. Cl. CPC G10L 15/16; G10L 15/02; G10L 2015/025

(57) ABSTRACT

A speech recognition method includes obtaining a speech recognition model including a plurality of feature aggregation nodes connected via a first type operation element, where a context-dependent operation of the first type operation element is based on past speech data and is independent of future speech data. The method further includes receiving streaming speech data, the speech data comprising audio data including speech, and processing the streaming speech data via the speech recognition model to obtain a speech recognition text corresponding to the streaming speech data, and outputting the speech recognition text.

### RELATED APPLICATIONS

This application is a continuation of International Application No. PCT/CN2022/070388, entitled “SPEECH RECOGNITION METHOD AND APPARATUS, COMPUTER DEVICE, AND STORAGE MEDIUM,” and filed on Jan. 5, 2022, which claims priority to Chinese Patent Application No. 202110036471.8, entitled “SPEECH RECOGNITION METHOD, DEVICE, COMPUTER DEVICE AND STORAGE MEDIUM”, and filed on Jan. 12, 2021. The entire disclosures of the prior applications are hereby incorporated by reference.

### FIELD OF THE TECHNOLOGY

This application relates to the technical field of speech recognition, including a speech recognition method, an apparatus, a computer device and a storage medium.

### BACKGROUND OF THE DISCLOSURE

Speech recognition is a technology that recognizes speech as text, which has a wide range of applications in various artificial intelligence (AI) scenarios.

In the related art, in order to ensure the accuracy of speech recognition, a speech recognition model needs to refer to the context information of speech in the process of recognizing input speech, that is to say, in response to recognizing speech data, the historical information and future information of the speech data shall be combined at the same time.

In the above-mentioned technical solution, since the speech recognition model introduces future information in the speech recognition process, a certain delay may be caused, limiting the application of the speech recognition model in streaming speech recognition.

### SUMMARY

The embodiments of this disclosure provide a speech recognition method, apparatus, computer device and storage medium, which can reduce a recognition delay under a streaming speech recognition scenario and improve the effect of the streaming speech recognition, and the technical solution is as follows.

In an embodiment, a speech recognition method includes obtaining a speech recognition model comprising a plurality of feature aggregation nodes connected via a first type operation element, where a context-dependent operation of the first type operation element is based on past speech data and is independent of future speech data. The method further includes receiving streaming speech data, the speech data comprising audio data including speech, and processing the streaming speech data via the speech recognition model to obtain a speech recognition text corresponding to the streaming speech data. The method further includes outputting the speech recognition text.

In an embodiment, a speech recognition method includes acquiring a speech training sample, the speech training sample comprising audio data including a speech sample and a speech recognition tag corresponding to the speech sample, and performing a neural architecture search on an initial network using the speech training sample to obtain a network search model. The initial network includes a plurality of feature aggregation nodes connected via a first type operation element, where a context-dependent operation of the first type operation element is based on past data of the speech training sample and is independent of future data of the speech training sample. The method further includes constructing a speech recognition model based on the network search model, the speech recognition model being configured to process inputted streaming speech data comprising audio data including speech to obtain a speech recognition text corresponding to the streaming speech data.

In an embodiment, a speech recognition apparatus includes processing circuitry configured to obtain a speech recognition model comprising a plurality of feature aggregation nodes connected via a first type operation element, wherein a context-dependent operation of the first type operation element is based on past speech data and is independent of future speech data. The processing circuitry is further configured to receive streaming speech data, the speech data including audio data including speech, and process the streaming speech data via the speech recognition model to obtain a speech recognition text corresponding to the streaming speech data. The processing circuitry is further configured to output the speech recognition text.

By setting the specified operation (context-dependent operation) which needs to rely on the context information in the operation space corresponding to the first type operation element in the initial network to be independent of the future data, a neural architecture search is then performed on the initial network to construct a speech recognition model. Due to the introduction of the specified operation which is not dependent on future data in the model and a model structure with high accuracy that is found out via the neural architecture search, the solution can ensure the accuracy of speech recognition, reduce the recognition time delay in the context of streaming speech recognition, and improve the effect of streaming speech recognition.

### BRIEF DESCRIPTION OF THE DRAWINGS

FIG. 1 is a diagram of a model search and speech recognition framework according to an exemplary embodiment;

FIG. 2 is a flow diagram illustrating a speech recognition method according to an exemplary embodiment;

FIG. 3 is a flow diagram illustrating a speech recognition method according to an exemplary embodiment;

FIG. 4 is a flow diagram illustrating a speech recognition method according to an exemplary embodiment;

FIG. 5 is a schematic diagram of a architecture according to the embodiment shown in FIG. 4;

FIG. 6 is a schematic diagram of a convolution operation according to the embodiment shown in FIG. 4;

FIG. 7 is a schematic diagram of another convolution operation according to the embodiment shown in FIG. 4;

FIG. 8 is a schematic diagram of a causal convolution according to the embodiment shown in FIG. 4;

FIG. 9 is a schematic diagram of another causal convolution according to the embodiment shown in FIG. 4;

FIG. 10 is a schematic diagram of a model construction and speech recognition framework according to an exemplary embodiment;

FIG. 11 is a block diagram illustrating a structure of a speech recognition apparatus according to an exemplary embodiment;

FIG. 12 is a block diagram illustrating a structure of a speech recognition apparatus according to an exemplary embodiment; and

FIG. 13 is a schematic structural diagram of a computer device according to an exemplary embodiment.

### DESCRIPTION OF EMBODIMENTS

Before describing the embodiments shown in this disclosure, several concepts in this disclosure are first introduced.

### 1) Artificial Intelligence (Artificial Intelligence, AI)

AI is a theory, method, technology, and application system that uses a digital computer or a machine controlled by the digital computer to simulate, extend, and expand human intelligence, perceive an environment, acquire knowledge, and use knowledge to obtain an optimal result. In other words, AI is a comprehensive technology in computer science. This technology attempts to understand the essence of intelligence and produce a new intelligent machine that can react in a manner similar to human intelligence. AI is to study the design principles and implementation methods of various intelligent machines, so that the machines can perceive, infer, and make decisions.

The AI technology is a comprehensive subject, relating to a wide range of fields, and involving both hardware and software techniques. Basic AI technologies generally include technologies such as a sensor, a dedicated AI chip, cloud computing, distributed storage, a big data processing technology, an operating/interaction system, and electromechanical integration. An AI software technology mainly includes several major fields such as a computer vision (CV) technology, a speech processing technology, a natural language processing technology, and machine learning/deep learning (DL).

### 2) Neural Architecture Search, NAS

Neural architecture search is a strategy that uses an algorithm to design a neural network, that is, in the case of uncertain network length and structure, to manually set a certain search space, and to find the best architecture on the validation set according to the designed search strategy from the search space.

Neural architecture search technology includes three parts: search space, search strategy, and evaluation and prediction, and is divided into three parts: NAS based on reinforcement learning, NAS based on genetic algorithm (also called evolution-based NAS), and differentiable NAS (also called gradient-based NAS).

NAS based on reinforcement learning uses a recurrent neural network as a controller to generate sub-networks, then trains and evaluates the sub-networks to obtain their network performance (such as accuracy), and finally updates the parameters of the controller. However, the performance of the sub-network is not derivable, and the controller cannot be directly optimized. Only the method of reinforcement learning can be used to update controller parameters on the basis of strategy gradient method. However, limited by the nature of its discrete optimization, this kind of method is too computationally intensive, because in this kind of NAS algorithm, in order to fully exploit the “potential” of each sub-network, the controller samples one sub-network at a time, initializes its network weights to train from the beginning and then verifies its performance. In contrast, the differentiable NAS based on gradient optimization shows great efficiency advantage. Differential NAS based on gradient optimization constructs the entire search space as a super-network, and then models the training and search process as a bi-level optimization problem. It does not sample a subnet separately and verify its performance by training from the beginning. Since the super-network itself is composed of a set of subnets, it uses the performance that an accuracy of the current super-network approximates the current most probable subnet, so it has very high search efficiency and performance and gradually becomes the mainstream of neural architecture search methods.

### 3) Super-network

A super-network is a set containing all possible subnets in a differentiable NAS. A developer can design a large search space, and the search space constitutes a super-network, where the super-network includes a plurality of sub-networks, and after training, each sub-network can be evaluated as a performance indicator, and the neural architecture search is to find a sub-network with the best performance indicator from these sub-networks.

### 4) Speech Technology (Speech Technology, ST)

Key technologies of the speech technology include an automatic speech recognition (ASR) technology, a text to speech (TTS) technology, and a voiceprint recognition technology. To make a computer capable of listening, seeing, speaking, and feeling is the future development direction of human-computer interaction, and speech has become one of the most promising human-computer interaction methods in the future.

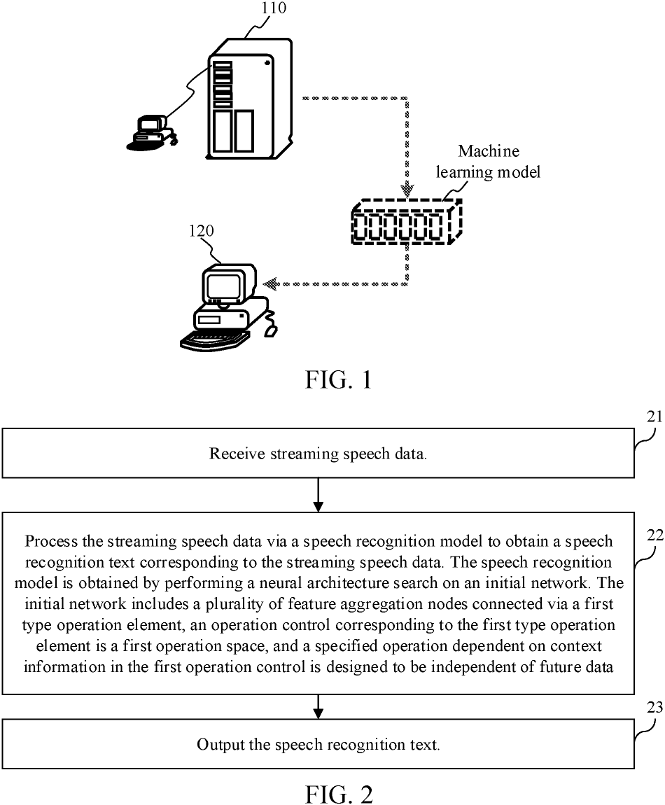

The solution of an embodiment of this disclosure includes a model search phase and a speech recognition phase. FIG. 1 is a diagram of a model search and speech recognition framework according to an exemplary embodiment. As shown in FIG. 1, in a model search stage, a model training device 110 performs a neural architecture search on a pre-set initial network via a pre-set speech training sample, and constructs a speech recognition model with a higher accuracy based on the search result. In a speech recognition stage, a speech recognition device 120 recognizes a speech recognition text in streaming speech data according to the constructed speech recognition model and the inputted streaming speech data.

The above-mentioned initial network may refer to a search space in a neural architecture search or a super-network. The obtained speech recognition model may be a sub-network in a super-network.

The model training device 110 and the speech recognition device 120 may be a computer device with a machine learning capability. For example, the computer device may be a fixed computer device such as a personal computer, a server, or the like. Alternatively, the computer device may further be a mobile computer device such as a tablet computer, a, an e-book reader, or the like.

The model training device 110 and the speech recognition device 120 may be the same device. Alternatively, the model training device 110 and the speech recognition device 120 may further be different devices. Moreover, when the model training device 110 and the speech recognition device 120 are different devices, the model training device 110 and the speech recognition device 120 may be the devices of the same type. For example, the model training device 110 and the speech recognition device 120 may both be personal computers. Alternatively, the model training device 110 and the speech recognition device 120 may further be devices of different types. For example, the model training device 110 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The speech recognition device 120 may be a smartphone, a tablet computer, a notebook computer, a desktop computer, a smart speaker, a smartwatch, or the like, but is not limited thereto. The terminal and the server may be directly or indirectly connected in a wired or wireless communication manner. This is not limited in this disclosure.

In the solutions shown in various embodiments of this disclosure, the above-mentioned model training device constructs a speech recognition model by performing a neural architecture search on an initial network and based on the search result, and the application scenarios thereof may include and are not limited to the following application scenarios:

1, network conference scenarios.

In a transnational network conference, an application of speech recognition is usually involved. For example, for streaming conference speech, a speech recognition text is recognized through a speech recognition model, and the speech recognition text is displayed in a display screen of the network conference, and the recognized speech recognition text can also be displayed after translation (for example, by text or speech) if necessary. With the speech recognition model involved in this disclosure, low-delay speech recognition can be performed, so as to satisfy instant speech recognition in a network conference scenario.

2, video/speech live scenarios.

In network live, speech recognition applications are also involved, e.g. live scenes usually require subtitles to be added to the live picture. Generally, the speech recognition model involved in this disclosure can realize the recognition of speech in a live stream with a low delay, so as to generate subtitles as soon as possible and add same to the live stream, which is of great significance for reducing the delay of live broadcast.

3, instant translation scenarios.

In many meetings, when two or more participants use different languages, specialized translators are often required to perform the interpretation. With the speech recognition model involved in this disclosure, it is possible to realize low-delay recognition of the speech spoken by a participant so as to quickly display the recognized text or translated speech and display same via a display screen, realizing automatic instant translation.

FIG. 2 is a flow diagram illustrating a speech recognition method according to an exemplary embodiment. The method may be performed by the speech recognition device in the embodiment shown in FIG. 1 described above. As shown in FIG. 2, the speech recognition method may include the following steps:

Step 21: Receive streaming speech data. For example, streaming speech data is received, the speech data comprising audio data including speech.

In an embodiment, the streaming speech data is audio stream data generated by encoding real-time speech, and the streaming speech data has a high delay requirement for speech recognition, namely, it needs to ensure that the delay between the inputted streaming speech data and the output speech recognition result is short.

Step 22: Process the streaming speech data via a speech recognition model to obtain a speech recognition text corresponding to the streaming speech data. The speech recognition model is obtained by performing a neural architecture search on an initial network. The initial network includes a plurality of feature aggregation nodes connected via a first type operation element, an operation control corresponding to the first type operation element is a first operation space, and a specified operation dependent on context information in the first operation control is designed to be independent of future data. For example, the streaming speech data is processed via a speech recognition model to obtain a speech recognition text corresponding to the streaming speech data. The speech recognition model including a plurality of feature aggregation nodes connected via a first type operation element is obtained. A context-dependent operation of the first type operation element is based on past data of the streaming speech data and is independent of future data of the streaming speech data.

The speech recognition model is a streaming speech recognition model (Streaming ASR Model). Different from the non-streaming speech recognition model in processing non-streaming speech data, the speech recognition results must be fed back after processing of the complete sentence audio, and the streaming speech recognition model can support real-time speech recognition results when processing the streaming speech data.

Here, the above-mentioned future data refers to other speech data located after the currently recognized speech data in time domain. For a specified operation dependent on future data, when the current speech data is recognized through the specified operation, it is necessary to wait for future data to arrive so as to complete the recognition of the current speech data, which results in a certain delay, and as such operation increases, the delay for completing the recognition of the current speech data also increases.

However, for a specified operation that is independent of the future data, when the current speech data is recognized through the specified operation, the recognition of the current speech data can be completed without waiting for the future data to arrive, and no delay caused by waiting for the future data is introduced in the process.

In one possible implementation, the specified operation that is independent of future data is an operation that can be performed during the feature processing of the speech data based on the current speech data and historical data prior to the current speech data.

Step 23: Output the speech recognition text.

In summary, in the solution shown in the embodiment of this disclosure, a specified operation which needs to rely on context information in an operation space corresponding to the first type operation element in the initial network is set to be independent of future data, and then a neural architecture search is performed on the initial network so as to construct a speech recognition model. Due to the introduction of specified operation that is independent of future data in the model, and the neural architecture search which can find out the model structure with high accuracy, the solution can ensure the accuracy of speech recognition, reduce the recognition time delay in the context of streaming speech recognition, and improve the effect of streaming speech recognition.

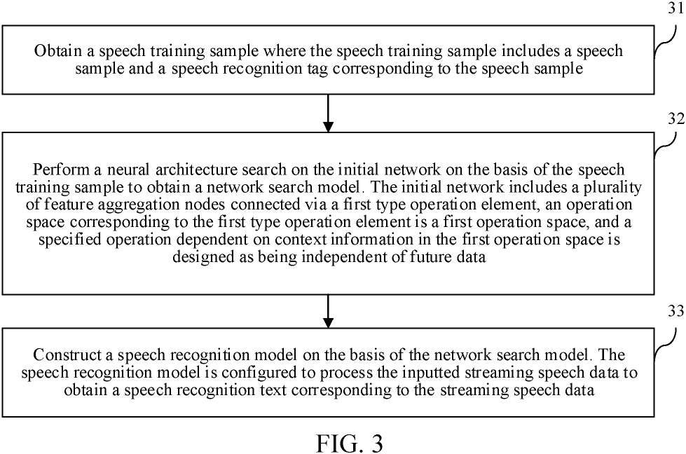

FIG. 3 is a flow diagram illustrating a speech recognition method according to an exemplary embodiment. The method may be performed by the model training device in the embodiment shown in FIG. 1 described above, and the speech recognition method may be a method performed based on a neural architecture search. As shown in FIG. 3, the speech recognition method may include the following steps:

Step 31: Obtain a speech training sample where the speech training sample includes a speech sample and a speech recognition tag corresponding to the speech sample. For example, a speech training sample is acquired, the speech training sample includes audio data including a speech sample and a speech recognition tag corresponding to the speech sample.

Step 32: Perform a neural architecture search on the initial network on the basis of the speech training sample to obtain a network search model. The initial network includes a plurality of feature aggregation nodes connected via a first type operation element, an operation space corresponding to the first type operation element is a first operation space, and a specified operation dependent on context information in the first operation space is designed as being independent of future data. For example, a neural architecture search is performed on an initial network using the speech training sample to obtain a network search model. The initial network includes a plurality of feature aggregation nodes connected via a first type operation element, where a context-dependent operation of the first type operation element is based on past data of the speech training sample and is independent of future data of the speech training sample.

In order to reduce the time delay of speech recognition, the embodiment of this disclosure improves the traditional NAS scheme, and designs the specified operation (neural network operation) in the operation space which originally depends on historical data and future data as only depending on historical data, i.e. designing the specified operation as a time delay-free manner, so that a neural architecture with a low time delay is found out in the subsequent neural architecture search process.

In an embodiment, the first type of operation element is derived from a combination of at least one operation in the first operation space.

Step 33: Construct a speech recognition model on the basis of the network search model. The speech recognition model is configured to process the inputted streaming speech data to obtain a speech recognition text corresponding to the streaming speech data. For example, a speech recognition model is constructed based on the network search model, the speech recognition model being configured to process inputted streaming speech data comprising audio data including speech to obtain a speech recognition text corresponding to the streaming speech data.

In summary, in the solution shown in the embodiment of this disclosure, a specified operation which needs to rely on context information in an operation space corresponding to a first type operation element in the initial network is set to be independent of future data, and then a neural architecture search is performed on the initial network so as to construct a speech recognition model. Due to the introduction of the specified operation that is independent on future data in the model, and the neural architecture search that can find out the model structure with high accuracy, the solution can ensure the accuracy of speech recognition, reduce the recognition time delay in the context of streaming speech recognition, and improve the effect of streaming speech recognition.

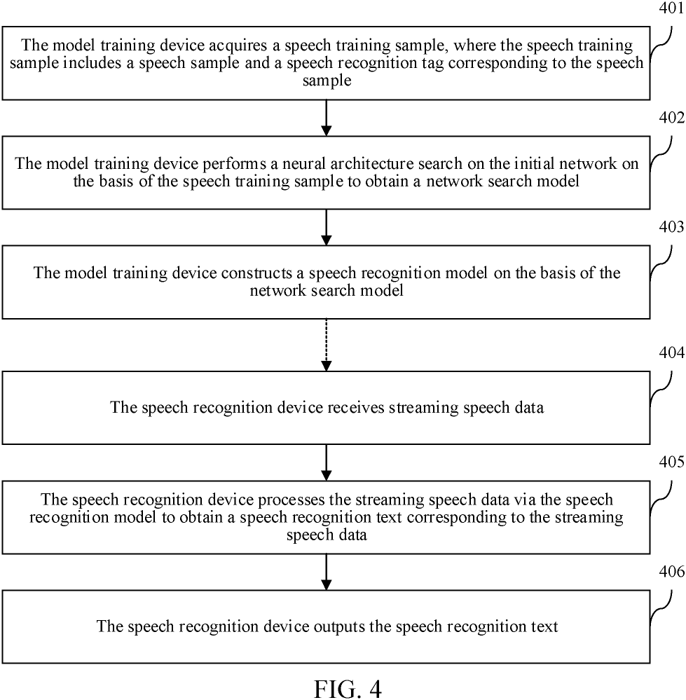

FIG. 4 is a flow diagram illustrating a speech recognition method according to an exemplary embodiment. The method may be performed by a model training device and a speech recognition device, where the model training device and the speech recognition device may be implemented as a single computer device or may belong to different computer devices. The method may include the steps as follows:

Step 401: The model training device acquires a speech training sample, where the speech training sample includes a speech sample and a speech recognition tag corresponding to the speech sample.

The speech training sample is a sample set collected in advance by a developer, and the speech training sample includes each speech sample and a speech recognition tag corresponding to the speech sample, and the speech recognition tag is used for training and evaluating a model in a subsequent architecture search process.

In one possible implementation, the speech recognition tag includes acoustic recognition information of the speech sample. The acoustic recognition information includes phonemes, syllables or semi-syllables.

In the solution shown in this disclosure, the purpose of performing a model search on the initial network is to construct an acoustic model with high accuracy, the speech recognition tag may be information corresponding to the outputted result of the acoustic model, such as phonemes, syllables or semi-syllables, etc.

In one possible implementation, the speech sample may be pre-sliced into several short-term speech segments (also called speech frames) with overlap, each speech frame corresponding to a respective phoneme, syllable or semi-syllable. For example, typically for speech with a sampling rate of 16 K, the length of the speech after segmentation is 25 ms and the overlap between frames is 15 ms, a process also referred to as “framing”.

Step 402: The model training device performs a neural architecture search on the initial network on the basis of the speech training sample to obtain a network search model.

The initial network includes a plurality of feature aggregation nodes connected via operation elements, the operation elements between the plurality of feature aggregation nodes include a first type operation element, and a specified operation dependent on context information contained in the first operation space corresponding to the first type operation element is designed to be independent of future data. A combination of one or more operations in the first operation space is used for implementing the first type of operand. The specified operation is a neural network operation that depends on context information.

In the embodiment of this disclosure, the above-mentioned first operation space may contain, in addition to a specified operation dependent on context information, an operation independent of context information, such as a residual concatenation operation, etc. and the embodiment of this disclosure does not define the type of operation contained in the first operation space.

In one possible implementation, the initial network includes n unit networks including at least one first unit network including an input node, an output node, and at least one of the feature aggregation nodes connected via the first type operation element.

In one exemplary aspect, the initial network may be partitioned by unit networks, each unit network including an input node and an output node, and one or more feature aggregation nodes between the input node and the output node.

The search space of each unit network in the initial network may be the same or different.

In one possible implementation, the n-unit networks are connected by at least one of the following connection manners:
bi-chain-styled, chain-styled, and densely-connected connection manners.

In one exemplary arrangement, the unit networks in the initial network are connected by pre-established links, and the links between different unit networks may be the same or different.

In the solution shown in the embodiment of this disclosure, there is no limitation on the connection manner between the respective unit networks in the initial network.

In one possible implementation, the n-unit network includes at least one second unit network including an input node, an output node and at least one feature aggregation node connected via a second type operation element; A second operation space corresponding to the second type operation element contains the specified operation dependent on future data. A combination of one or more operations in the second operation space is used for implementing the second type operation element.

Alternatively, in addition to the above-mentioned specified operation which is not dependent on future information (low delay/controllable delay), a part of the specified operations which need to be dependent on future information (high delay/uncontrollable delay), i.e. the above-mentioned specified operation which is dependent on future data, may be included in the search space of the initial network to ensure that the future information of the current speech data can be utilized while reducing the speech recognition delay and ensuring the accuracy of speech recognition.

In one possible implementation, topology is shared between at least one of the first unit networks, or a topology and network parameters are shared among at least one of the first unit networks. A topology is shared between at least one of the second unit networks, or a topology and network parameters are shared among at least one of the second unit networks.

In an exemplary solution, when an initial network is divided into unit networks and divided into two or more different types of unit networks, in order to reduce the complexity of network search, the topology and network parameters may be shared among the same type of unit networks during the search process.

In other possible implementations, the topology may be shared, or the network parameters may be shared, among the same type of unit networks during the search.

In other possible implementations, the topology and network parameters may also be shared among partial unit networks in the same type of unit networks. For example, assuming that the initial network includes four first unit networks, where one set of topology and network parameters is shared between two first unit networks and another set of topology and network parameters is shared between two other first unit networks.

In other possible implementations, the individual unit networks in the initial network may not share network parameters.

In one possible implementation, the specified operation designed to be independent of future data is a causality-based specified operation.

Alternatively,
specified operations that are designed to be independent of future data are mask-based specified operations.

No future data is relied upon for a specified operation, this may be done in a causality-based manner or may be done in a mask-based manner. Of course, other possible ways than causality-based manner and mask-based manner may be used to make a specified operation independent of future data, and embodiments of the present disclosure are not limited thereto.

In one possible implementation, the feature aggregation node is configured to perform at least one of a summation operation, a concatenation operation, and a multiplication operation on the inputted data.

In one exemplary solution, the operation corresponding to each feature aggregation node in the initial network may be fixedly set to one operation, e.g. to a summation operation.

Alternatively, in other possible implementations, the above-mentioned feature aggregation nodes may be respectively set as different operations, for example, a part of the feature aggregation nodes are set as a summation operation, and a part of the feature aggregation nodes are set as a concatenation operation.

Alternatively, in other possible implementations, the feature aggregation nodes described above may not be fixed as specific operations, where the operation corresponding to each feature aggregation node may be determined during the neural architecture search.

In one possible implementation, the specified operation includes at least one of a convolution operation, a pooling operation, a Long Short-Term Memory (LSTM) based operation, and a Gated Recurrent Unit (GRU) based operation. Alternatively, the above-mentioned specified operation may also include other convolution neural network operations depending on context information, and the embodiments of this disclosure do not limit the operation type of the specified operations.

In an embodiment of this disclosure, the model training device performs a neural architecture search based on an initial network so as to determine the network search model with higher accuracy. In the above-mentioned search process, the model training device performs machine learning training and evaluation on each sub-network in the initial network via the speech training sample so as to determine information, such as whether the feature aggregation node in the initial network remains, whether each operation element between the retained feature aggregation nodes remains, an operation type corresponding to the retained operation element, each operation source and a parameter of the feature aggregation node thus determining a subnet with a suitable topology and an accuracy satisfying the requirements from the initial network as the network search model obtained by searching.

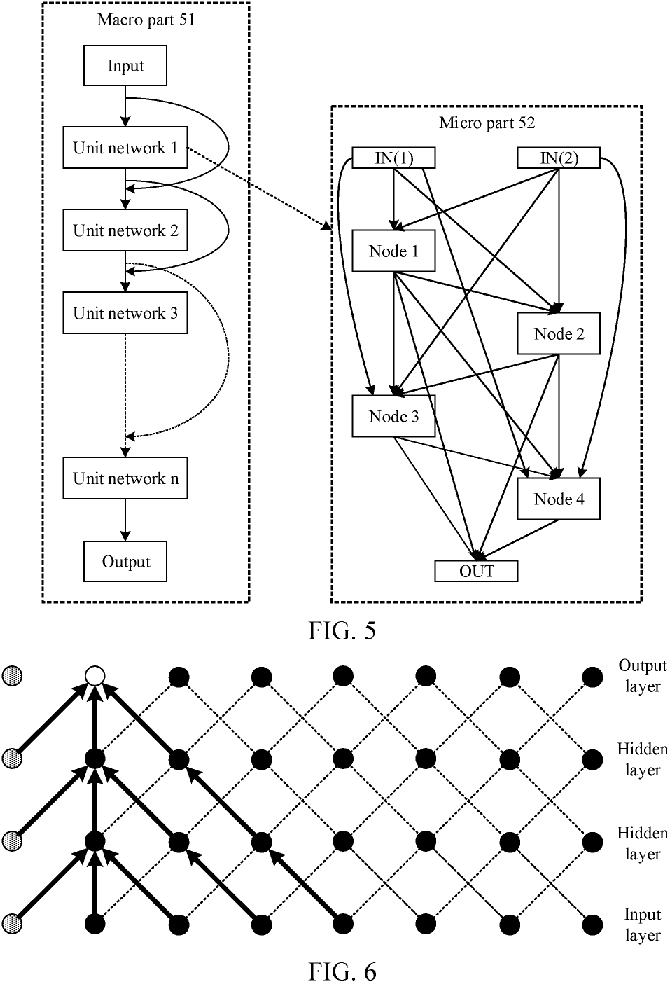

In FIG. 5, a schematic diagram of a network architecture according to an embodiment of this disclosure is shown. As shown in FIG. 5, taking a neural architecture search (NAS) method based on a cell structure as an example, FIG. 5 provides a schematic diagram of a NasNet-based search space, where a connection mode between cell (unit network) of a macro part 51 is a bi-chain-styled mode, and a node structure of a micro part 52 is an op_type (operation type) + connection (connection point).

The solution shown in the embodiments of this disclosure is based on the topology shown in FIG. 5, and the following description of the search space is made by taking this topology as an example. As shown in FIG. 5, the construction of a search space is generally divided into two steps: macro architecture and micro architecture.

The link mode of the macro structure part is bi-chain-styled, the input of each cell is the output of the first two cells, and the link mode is a fixed artificial design topology and does not participate in the search. The number of layers of the cell is variable, the search phase can be different from the evaluation phase (based on the found structure), and the number of layers of the cell can be different facing different tasks.

In some NAS algorithms, the link mode of the macro structure can also participate in the search, namely, a non-fixed bi-chain-styled link mode, and the embodiments of this disclosure are not limited thereto.

Micro structure is the topology within cell. As shown in FIG. 5, it can be seen as a directed acyclic graph. Nodes IN (1) and IN (2) are input nodes (node) of the cell, and node 1, node 2, node 3 and node 4 are intermediate nodes corresponding to the above-mentioned feature aggregation nodes (the number being variable). The input of each node is the output of all the previous nodes, namely, the input of the node node 1 is IN (1), IN (2), the input of the node node 2 is IN (1), IN (2), node 1. The rest can be done in the same manner. Node OUT is the output node and its inputs are the outputs of all intermediate nodes.

The NAS algorithm searches for an optimal link relationship (i.e. topology) based on the link relationships in the initial model. A fixed candidate operation set (namely, an operation space) is predefined between every two nodes, for example, operations such as 3x3 convolution (convolution) and 3x3 average pooling (average pooling), which are respectively used for processing inputs of the nodes. The candidate operation predefines a summarization function set (i.e. various types of feature aggregation operations) after processing the input, such as functions of sum, concat, product, etc. NAS algorithm preserves an optimal candidate operation/function based on all candidate operations/functions when performing neural architecture search on the basis of training samples. The application example in the present solution can fix the summarization function = sum function, and only search the topology in the cell and the candidate operations. The following description of the search algorithm is introduced as an example of such a search space. Alternatively, the summarization function may be fixedly set as another function, or the summarization function may not be fixedly set.

In the task of streaming speech recognition, it is difficult for the traditional NAS method to generate a low-latency architecture of streaming speech recognition model. Taking the DARTS-based search space as an example, macro structure is designed as two cell structures:

normal cell, where the time-frequency domain resolution of input and output remains unchanged; and reduction cell, where the time-frequency domain resolution of the output is half of the input.

Reduction cells are fixed as two layers, which are respectively located at ⅓ and ⅔ of the whole network, and the rest are all normal cells. The application examples shown in the embodiments of this disclosure are introduced by taking the same method of macro structure and DARTS as an example, and the following description of macro structure is made with the above-mentioned topology which will not be repeated. On the basis of the above-mentioned search space, a search algorithm generates a final micro structure, where normal cells share the same topology and a corresponding operation, and reduction cells share the same topology and a corresponding operation. In the DARTS-based search space, both the convolution operation and the pooling operation depend on the future information (relative to the current time), so normal cell and reduction cell in the architecture generated by the NAS algorithm respectively generate delay. For different tasks, the number of layers of normal cell will change, and the delay will change accordingly. On the basis of the principle, the generated architecture delay increases with the number of network layers. In order to more clearly describe the concept of the above-mentioned delay, taking the generated architecture in which the delay of the normal cell is 4 frames and the delay of the reduction cell is 6 frames as an example, the network delay of the 5 layers of cells = 4 + 6 + 2 * (4 + 6 + 2 * (4)) = 46 frames is calculated, and the number 2 in the calculation formula is a multiplication calculation factor added by halving the time-frequency domain resolution in the reduction cell. Further, the network delay for 8 layers of cells = (4 + 4) + 6 + 2 * ((4 + 4) + 6 + 2 * (4 + 4)) = 74 frames is calculated. The rest can be done in the same manner. Obviously, as the number of layers of the cell increases, the overall network delay increases rapidly.

In order to clearly understand the concept of speech delay in the NAS algorithm, the implementation of the specified operation is introduced by taking the convolution operation in the convolution neural network as an example. In the application example related to the embodiment of this disclosure, the search space is mainly a convolutional neural network, and the inputted speech feature is feature map (which can be understood as a picture), namely, the speech feature is FBank second-order difference feature (40-dimensional log Mel-filterbank features with the first-order and the second-order derivatives), where the first-order difference feature and the second-order difference feature respectively correspond to an additional channel (the channel concept in the picture), the feature map of the speech feature has a width corresponding to the frequency domain resolution (40 dimensions) and a height corresponding to the length of the speech (the number of frames).

Speech feature map generally depends on future information when it is processed by traditional candidate operations. In FIG. 6, a diagram of a convolution operation according to an embodiment of this disclosure is shown. As shown in FIG. 6, taking the 3 * 3 convolution operation as an example, the first behavior input is on the lower side (each column is one frame), the hidden layer is in the middle (each layer goes through a 3 * 3 convolution operation), the output is on the upper side, and the dots are filled with patterns on the left side are padding frames. FIG. 6 is a schematic diagram applying 3 layers of 3 * 3 convolution operation, the dots without filling in the output layer are the output of the first frame, and the coverage of the solid arrows in the input layer is all the dependent information, i.e. three frames of inputted information in future are required. The logic of other candidate operations is similar, and the dependence on future information increases as the hidden layer increases.

More intuitively, reference is made to FIG. 7, which shows a schematic diagram of another convolution operation according to an embodiment of this disclosure. As shown in FIG. 7, the inputted speech data passes through two hidden layers, the first hidden layer including a 3 * 3 convolution operation, and the second hidden layer including a 5 * 5 convolution operation. The first 3 * 3 convolution operation needs to use historical frame information and future frame information to calculate the output of the current frame. In the second 5 * 5 convolution operation, the input is the output of the first hidden layer, which requires the use of historical two frames of information and future two frames of information to calculate the output of the current frame.

On the basis of the foregoing introduction, it is difficult for the traditional NAS method to effectively control the delay of searching the architecture, especially in large-scale speech recognition tasks, where the architecture has more cell layers and the corresponding delay increases linearly. For the streaming speech recognition task, aiming at the problems existing in the traditional NAS algorithm, the embodiment of this disclosure proposes a latency-controlled NAS algorithm. Unlike the structure designs of normal cell and reduction cell in traditional algorithms, the algorithm shown in the embodiment of this disclosure proposes a latency-controlled cell structure, replacing the normal cell therein, namely, the macro structure of the new algorithm is composed of both latency-free cell and reduction cell. The latency-free cell structure is a delay-free structure, no matter what kind of topology and candidate operation the micro structure obtained by the final search of the NAS algorithm is, the cell itself will not generate delay. The advantage of this structure design is that when the architecture obtained through searching migrates to various tasks, increasing and decreasing the number of latency-free cell will not change the delay of the whole network, and the delay is completely determined by a fixed number of reduction cells, so that the delay can be controlled while the delay is reduced.

In an application example of an embodiment of this disclosure, an implementation solution of a latency-free cell structure design is that a candidate operation (namely, an operation space, such as a convolution operation, a pooling operation, etc.) within a cell is designed as a delay-free operation mode.

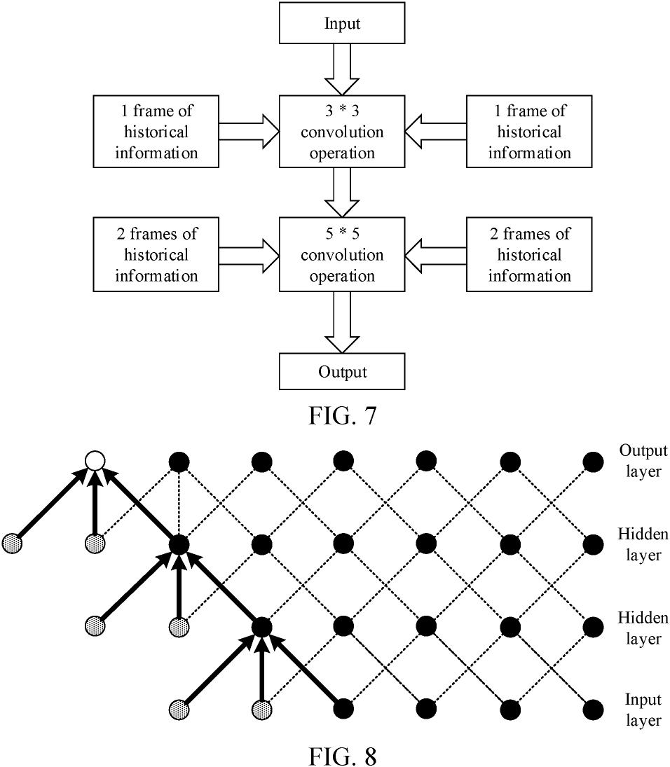

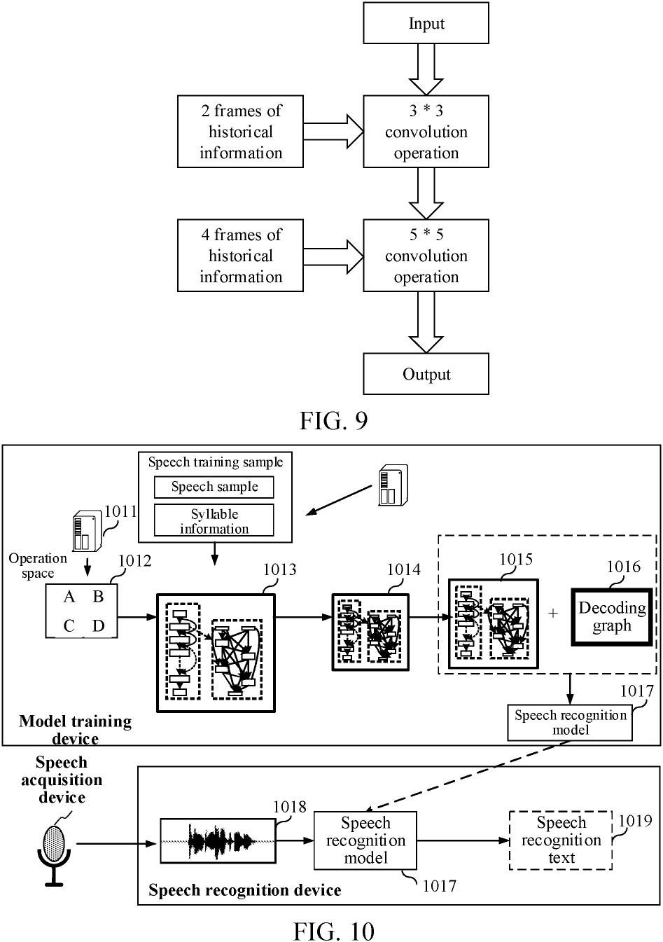

Taking a convolution operation as an example, a non-time delay design may change the convolution operation from a non-causal convolution operation to a causal convolution. The operation of the non-causal convolution can be seen with reference to FIGS. 6 and 7 and the corresponding description depending on future information. In FIG. 8, a schematic diagram of a causal convolution is shown in accordance with an embodiment of this disclosure. As shown in FIG. 8, the causal convolution differs from the ordinary convolution in that the output of the white filled dots of the output layer corresponds to the coverage of the solid arrows of the input layer, i.e. the calculation at the current moment depends only on past information (e.g., past speech data) and not on future information (e.g., future speech data). In addition to convolution operations, other candidate operations that depend on future information (e.g. pooling operations) may employ similar causal processing methods as described above, i.e. the calculation of the current time depends only on past information. For another example, in FIG. 9, a schematic diagram of another causal convolution according to an embodiment of this disclosure is shown. As shown in FIG. 9, compared with the non-causal operation, the input of the causal convolution passes through two hidden layers, the first hidden layer containing a 3 * 3 convolution operation and the second hidden layer containing a 5 * 5 convolution operation. The first 3 * 3 convolution operation needs to use two frames of historical information to calculate the output of the current frame. The second 5 * 5 convolution operation, of which the input is the output of the first hidden layer, needs to use four frames of historical information to calculate the output of the current frame.

In the above-mentioned latency-controlled NAS algorithm proposed by an embodiment of this disclosure, macro structure is composed of latency-free cell and reduction cell, and the micro structure of latency-free cell constitutes a search space by candidate operations without time delay. In the neural architecture obtained by searching with the new algorithm, the delay of the model is only determined by a fixed number of reduction cells, which can generate a low-delay streaming speech recognition model architecture.

As previously stated, the application examples in the embodiments of this disclosure are realized with a bi-chain-styled cell structure, and can be extended to more structures in the following manner.

1) Macro structure level is based on the design of cell structure, and the link mode between cells can also include chain-styled mode, densely-connected mode, etc.
2) At the Macro structure level, the design of the structure is similar to the cell structure.
3) In the direction of Micro structure design, the candidate operation design without time delay is in a causality-based manner, and the candidate operation design without time delay can also be implemented in a mask-based manner. For example, the above-mentioned convolution operation can be implemented as a convolution operation based on a Pixel convolution neural network (Pixel CNN).

Step 403: The model training device constructs a speech recognition model on the basis of the network search model.

The speech recognition model is configured to process the inputted streaming speech data to obtain a speech recognition text corresponding to the streaming speech data.

In the solution shown in this disclosure, when the purpose of performing model search on the initial network is to construct an acoustic model with high accuracy, a model training device can construct an acoustic model on the basis of the network search model. The acoustic model is configured to process the streaming speech data to obtain acoustic recognition information about the streaming speech data. A speech recognition model is then constructed on the basis of the acoustic model and the decoding graph.

A speech recognition model usually includes an acoustic model and a decoding graph, where the acoustic model is configured to recognize acoustic recognition information, such as phonemes, syllables, etc. from inputted speech data, and the decoding graph is used for obtaining corresponding recognition text according to the acoustic recognition information recognized by the acoustic model.

The decoding graph typically includes, but is not limited to, a phoneme/syllable dictionary and a language model, where the phoneme/syllable dictionary typically contains a mapping of characters or words to phoneme/syllable sequences. For example, a string of syllable sequence is input, and a syllable dictionary can output a corresponding word or phrase. Generally speaking, phoneme/syllable dictionaries are not related to the field of text and are common parts in different recognition tasks. Language models are usually transformed from n-gram language models, which are configured to calculate the probability of a sentence occurring, which are trained using training data and statistical methods. Generally speaking, in texts in different fields, such as texts of news and spoken dialogs, common words and collocations between words are quite different. Therefore, when speech recognition in different fields is performed, adaptation can be achieved by changing the language model.

In the latency-controlled NAS algorithm proposed in the embodiment of this disclosure, the structure delay of the neural network obtained by searching is only determined by a fixed number of reduction cells. When the model structure migrates to various application directions of speech recognition, the model delay after migration will not change as the number of cell layers in the model structure changes, especially for large-scale speech recognition tasks. The model structure after migration is very complex (the number of cell layers is very large), and it is difficult for the traditional NAS algorithm to effectively control the delay. In addition, the design of the new algorithm can ensure that the delay of the migrated model structure is fixed and adapt to various speech recognition tasks, including a large-scale speech recognition task, and the application example of this disclosure can generate a low-delay streaming recognition model architecture oriented to the large-scale speech recognition task.

Step 404: The speech recognition device receives streaming speech data.

After the above-mentioned speech recognition model is constructed, it can be deployed to a speech recognition device to perform the task of recognizing streaming speech. In a streaming speech recognition task, a speech acquisition device in a streaming speech recognition scenario may continuously acquire streaming speech and input same to the speech recognition device.

Step 405: The speech recognition device processes the streaming speech data via the speech recognition model to obtain a speech recognition text corresponding to the streaming speech data.

In one possible implementation, the speech recognition model includes an acoustic model and a decoding graph, the acoustic model being constructed based on the network search model.

The speech recognition device can process the streaming speech data via the acoustic model to obtain acoustic recognition information about the streaming speech data. The acoustic recognition information includes a phoneme, a syllable or a semi-syllable. The acoustic recognition information of the streaming speech data is then processed through the decoding graph to obtain the speech recognition text.

In the embodiment of this disclosure, when the acoustic model in the above-mentioned speech recognition model is a model constructed by the neural architecture search in the above-mentioned step, during the speech recognition process, the speech recognition device can process the streaming speech data through the acoustic model in the speech recognition model to obtain corresponding acoustic recognition information such as syllables or phonemes, and then input the acoustic recognition information into a decoding graph composed of a phonetic dictionary, a language model, etc. to decode same to obtain a corresponding speech recognition text.

Step 406: The speech recognition device outputs the speech recognition text.

In an embodiment of this disclosure, after the speech recognition device outputs the speech recognition text, the speech recognition text can be applied to subsequent processing, for example, presenting the speech recognition text or the translated text thereof as a subtitle, or converting the translated text of the speech recognition text into speech for playing, etc.

In summary, in the solution shown in the embodiment of this disclosure, a specified operation which needs to rely on context information is set as a specified operation that is not dependent on future data in the operation space of the first type operation element in the initial network, and then a neural architecture search is performed on the initial network so as to construct a speech recognition model. Due to the introduction of specified operations that do not depend on future data in the model, and through the neural architecture search which help find the model structure with high accuracy, the solution can ensure the accuracy of speech recognition, reduce the recognition time delay in the context of streaming speech recognition, and improve the effect of streaming speech recognition.

Taking the application of the solution shown in FIG. 4 to a streaming speech recognition task as an example, reference is made to FIG. 10, which is a schematic diagram of a model construction and speech recognition framework according to an exemplary embodiment.

In the model training device, a preset operation space 1012 is first read from an operation space memory 1011 (a specified operation being designed to be independent of future data), and a preset speech training sample (including a speech sample and corresponding syllable information) is read from a sample set memory. According to the preset speech training sample and the preset operation space 1012, a neural architecture search is performed on a preset initial network 1013 (such as the network shown in the above-mentioned FIG. 5) to obtain a network search model 1014.

Then, the model training device constructs an acoustic model 1015 on the basis of the network search model 1014, and the input of the acoustic model 1015 can be the syllables corresponding to the speech data and the historical recognition result of the speech data, and outputs the syllables are the predicted current speech data.

The model training device constructs a speech recognition model 1017 on the basis of the acoustic model 1015 described above and the preset decoding graph 1016, and deploys the speech recognition model 1017 into the speech recognition device.

In the speech recognition device, the speech recognition device acquires streaming speech data 1018 collected by the speech collection device, segments the streaming speech data 1018, inputs each speech frame obtained by the segmentation into the speech recognition model 1017, which performs recognition to obtain a speech recognition text 1019 and outputs the speech recognition text 1019 so as to perform operations such as presentation/translation/natural language processing on the speech recognition text 1019.

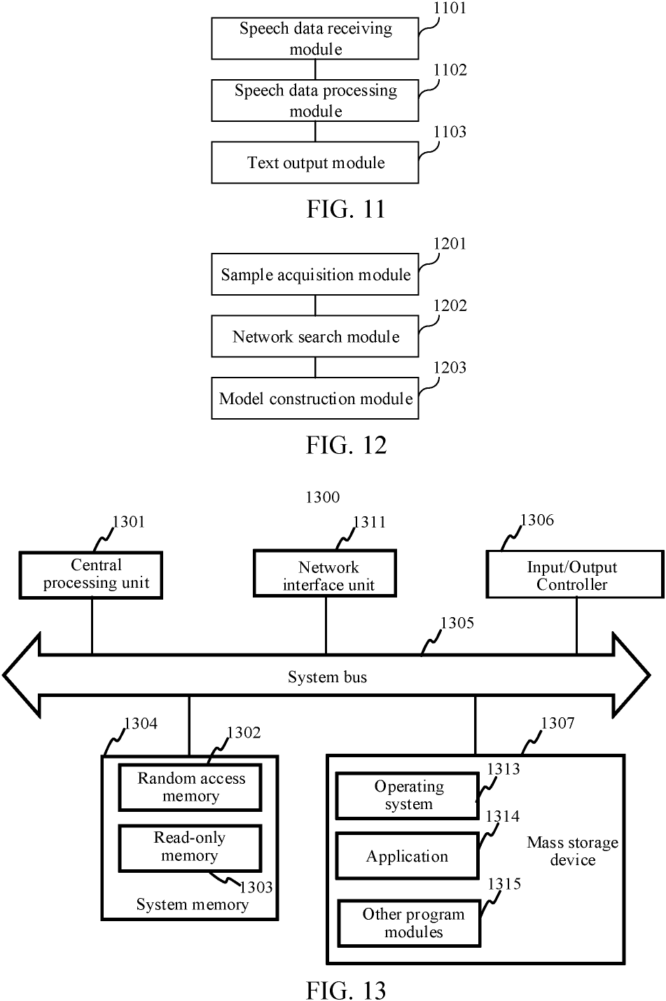

FIG. 11 is a block diagram illustrating a structure of a speech recognition apparatus according to an exemplary embodiment. The speech recognition apparatus may implement all or part of the steps in the method provided by the embodiment shown in FIG. 2 or FIG. 4, the speech recognition apparatus including:
a speech data receiving module 1101, configured to receive streaming speech data,
a speech data processing module 1102, configured to process the streaming speech data via a speech recognition model to obtain a speech recognition text corresponding to the streaming speech data, the speech recognition model being obtained by performing a neural architecture search on an initial network, the initial network including a plurality of feature aggregation nodes connected via a first type operation element, an operation space corresponding to the first type operation element being a first operation space, and a specified operation dependent on context information in the first operation space being designed to be independent of future data, and
a text output module 1103, configured to output the speech recognition text.

In one possible implementation, the initial network includes n unit networks, the n unit networks including at least a first unit network, the first unit network including an input node, an output node, and at least one the feature aggregation node connected by the first type operation element.

In one possible implementation, the n-unit networks are connected by at least one of the following connection manners:

a double link mode, a single link mode, and a dense link mode.

In one possible implementation, the n-unit network includes at least one second unit network, where the second unit network includes an input node, an output node and at least one the feature aggregation node connected by a second type operation element, a second operation space corresponding to the second type operation element containing the specified operation dependent on future data, a combination of one or more operations in the second operation space being used for implementing the second type operation element.

In one possible implementation, topology and network parameters are shared among at least one of the first unit networks and topology and network parameters are shared among at least one of the second unit networks.

In one possible implementation, the specified operation designed to be independent of future data is a causality-based specified operation,
or
the specified operation designed to be independent of future data is a mask-based specified operation.

In one possible implementation, the feature aggregation node is configured to perform at least one of a summation operation, a concatenation operation, and a multiplication operation on the inputted data.

In one possible implementation, the specified operation includes at least one of a convolution operation, a pooling operation, an operation based on a long short-term memory artificial neural network LSTM and an operation based on a gated recurrent unit GRU.

In one possible implementation, the speech recognition model includes an acoustic model and a decoding graph, where the acoustic model is constructed based on a network search model, and the network search model is obtained by performing a neural architecture search on the initial network via a speech training sample.

The speech data processing module 1102 is configured to
process the streaming speech data through the acoustic model to obtain acoustic recognition information about the streaming speech data, the acoustic recognition information including a phoneme, a syllable or a semi-syllable,
the speech recognition text being obtained by processing the acoustic recognition information of the streaming speech data through the decoding graph.

In summary, in the solution shown in the embodiment of this disclosure, a specified operation which needs to rely on context information in an operation space corresponding to a first type operation element in an initial network is set to be independent of future data, and then a neural architecture search is performed on the initial network so as to construct a speech recognition model. Due to the introduction of a specified operation that is not dependent of future data in the model, and the neural architecture search which help find out the model structure with high accuracy, the solution can ensure the accuracy of speech recognition, reduce the recognition time delay in the context of streaming speech recognition, and improve the effect of streaming speech recognition.

FIG. 12 is a block diagram illustrating a structure of a speech recognition apparatus according to an exemplary embodiment. The speech recognition apparatus may implement all or part of the steps in the method provided by the embodiment shown in FIG. 3 or FIG. 4, the speech recognition apparatus including:

a sample acquisition module 1201, configured to acquire a speech training sample, where the speech training sample contains a speech sample and a speech recognition tag corresponding to the speech sample,
a network search module 1202, configured to perform a neural architecture search on an initial network based on the speech training sample to obtain a network search model, the initial network including a plurality of feature aggregation nodes connected via a first type operation element, an operation space corresponding to the first type operation element being a first operation space, and a specified operation dependent on context information in the first operation space being designed to be independent of future data,
a model construction module 1203, configured to construct a speech recognition model based on the network search model, the speech recognition model is configured to process the inputted streaming speech data to obtain a speech recognition text corresponding to the streaming speech data.

In one possible implementation, the speech recognition tag includes acoustic recognition information of the speech sample. The acoustic recognition information includes a phoneme, a syllable or a semi-syllable.

The model construction module 1203 is configured to
construct an acoustic model on the basis of the network search model, the acoustic model being configured to process the streaming speech data to obtain acoustic recognition information about the streaming speech data,
on the basis of the acoustic model and the decoding graph, the speech recognition model being constructed.

In summary, in the solution shown in the embodiment of this disclosure, a specified operation which needs to rely on context information in an operation space corresponding to a first type operation element in an initial network is set to be independent of future data, and then a neural architecture search is performed on the initial network so as to construct a speech recognition model. Due to the introduction of specified operations that is not dependent of future data in the model, and the neural architecture search that helps find out the model structure with high accuracy, the solution can ensure the accuracy of speech recognition, reduce the recognition time delay in the context of streaming speech recognition, and improve the effect of streaming speech recognition.

FIG. 13 is a schematic structural diagram of a computer device according to an exemplary embodiment. The computer device may be implemented as a model training device and/or as a speech recognition device in the various method embodiments described above. The computer device 1300 includes a central processing unit (CPU) 1301, a random access memory (RAM) 1302, a system memory 1304 of a read-only memory (ROM) 1303, and a system bus 1305 connecting the system memory 1304 to the CPU 1301. The computer device 1300 further includes a basic input/output system 1306 assisting in transmitting information between components in the computer, and a mass storage device 1307 configured to store an operating system 1313, an application program 1314, and another program module 1315.

The mass storage device 1307 is connected to the CPU 1301 by using a mass storage controller (not shown) connected to the system bus 1305. The mass storage device 1307 and an associated computer-readable medium provide non-volatile storage for the computer device 1300. That is, the mass storage device 1307 may include a computer-readable medium (not shown) such as a hard disk, or a compact disc read-only memory (CD- ROM) drive.

Without loss of generality, the computer-readable medium may include a computer storage medium and a communication medium. The computer storage medium includes volatile and non-volatile media, and removable and non-removable media implemented by using any method or technology and configured to store information such as a computer-readable instruction, a data structure, a program module, or other data. The computer storage medium includes a RAM, a ROM, a flash memory or another solid-state memory technology, a CD-ROM, or another optical memory, a magnetic cassette, a magnetic tape, a magnetic disk memory, or another magnetic storage device. Certainly, a person skilled in the art may know that the computer storage medium is not limited to the foregoing types. The system memory 1304 and the mass storage device 1307 may be collectively referred to as a memory.

The computer device 1300 may be connected to the Internet or another network device by using a network interface unit 1311 connected to the system bus 1305.

The memory (including a non-transitory computer-readable storage medium) further includes at least one computer instruction. The at least one computer instruction is stored in the memory. A processor (including processing circuitry) implements all or part of the steps of the method shown in FIG. 2, FIG. 3 or FIG. 4 by loading and executing the at least one computer instruction.

In an exemplary embodiment, a non-temporary computer-readable storage medium including an instruction is further provided, such as a memory including a computer program (an instruction), and the program (the instruction) may be executed by a processor in a computer device to complete the methods in the embodiments of this disclosure. For example, the non-temporary computer-readable storage medium may be a ROM, a RAM, a CD- ROM, a magnetic tape, a floppy disk, an optical data storage device, or the like.

In an exemplary embodiment, a computer program product or a computer program is provided. The computer program product or the computer program includes computer instructions, and the computer instructions are stored in a computer-readable storage medium. A processor of a computer device reads the computer instructions from the computer-readable storage medium, and executes the computer instructions, causing the computer device to implement the methods shown in the foregoing embodiments.

In an embodiment, a non-transitory computer-readable storage medium stores computer-readable instructions which, when executed by a computer device, cause the computer device to perform a speech recognition method that includes receiving streaming speech data, the speech data comprising audio data including speech, and processing the streaming speech data via a speech recognition model to obtain a speech recognition text corresponding to the streaming speech data. The speech recognition model has been obtained by performing a neural architecture search on an initial network, the initial network including a plurality of feature aggregation nodes connected via a first type operation element. A context-dependent operation of the first type operation element is based on past data of the streaming speech data and is independent of future data of the streaming speech data. The method further includes outputting the speech recognition text.

In an embodiment, a non-transitory computer-readable storage medium stores computer-readable instructions which, when executed by a computer device, cause the computer device to perform a speech recognition method that includes acquiring a speech training sample, the speech training sample comprising audio data including a speech sample and a speech recognition tag corresponding to the speech sample, and performing a neural architecture search on an initial network using the speech training sample to obtain a network search model. The initial network includes a plurality of feature aggregation nodes connected via a first type operation element, where a context-dependent operation of the first type operation element is based on past data of the speech training sample and is independent of future data of the speech training sample. The method further includes constructing a speech recognition model based on the network search model, the speech recognition model being configured to process inputted streaming speech data comprising audio data including speech to obtain a speech recognition text corresponding to the streaming speech data.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. A speech recognition method comprising:
obtaining a speech recognition model comprising a plurality of feature aggregation nodes connected via a first type operation element, wherein a context-dependent operation of the first type operation element is based on past speech data and is independent of future speech data;
receiving streaming speech data, the speech data comprising audio data including speech;
processing the streaming speech data via the speech recognition model to obtain a speech recognition text corresponding to the streaming speech data; and
outputting the speech recognition text.

2. The method according to claim 1, wherein the obtaining comprises performing a neural architecture search on n unit networks comprising at least one first unit network comprising an input node, an output node, and at least one of the feature aggregation nodes connected by the first type operation element.

3. The method according to claim 2, wherein the performing the neural architecture search on the n unit networks comprises performing the neural architecture search on the n unit networks connected via at least one of:
a double link mode, a single link mode, and a dense link mode.

4. The method according to claim 2, wherein the performing the neural architecture search on the n unit networks comprises performing the neural architecture search on the n unit networks, including at least one second unit network comprising an input node, an output node and at least one of the feature aggregation nodes connected by a second type operation element, wherein the second type operation element is implemented using an operation dependent on the future speech data.

5. The method according to claim 4, wherein the performing the neural architecture search on the n unit networks comprises performing the neural architecture search on
at least one of the first unit networks, each of the at least one of the first unit networks sharing a topology or sharing the topology and a network parameter, and
at least one of the second unit networks, each of the at least one of the second unit networks sharing a topology or sharing the topology and a network parameter are.

6. The method according to claim 1, wherein the obtaining further comprises
obtaining the speech recognition model comprising the first type operation element having a causality-based specified operation or a mask-based specified operation as the context-dependent operation that is independent of the future speech data .

7. The method according to claim 1, wherein the obtaining further comprises
obtaining the speech recognition model comprising the feature aggregation nodes, which are configured to perform at least one of a summation operation, a concatenation operation, or a product operation on inputted data.

8. The method according to claim 1, wherein the obtaining further comprises
obtaining the speech recognition model comprising the first type operation element having at least one of a convolution operation, a pooling operation, an operation based on a long short-term memory artificial neural network (LSTM), or an operation based on a gated recurrent unit (GRU) as the context-dependent operation.

9. The method according to claim 1, wherein
the speech recognition model comprises an acoustic model and a decoding graph, the acoustic model being based on a network search model obtained by performing a neural architecture search on an initial network via a speech training sample, and
the processing the streaming speech data comprising:
processing the streaming speech data via the acoustic model to obtain acoustic recognition information of the streaming speech data, the acoustic recognition information comprising a phoneme, a syllable, or a semi-syllable,
the speech recognition text being obtained by processing the acoustic recognition information of the streaming speech data via the decoding graph.

10. A speech recognition method comprising:
acquiring a speech training sample, the speech training sample comprising audio data including a speech sample and a speech recognition tag corresponding to the speech sample,
performing a neural architecture search on an initial network using the speech training sample to obtain a network search model, the initial network comprising a plurality of feature aggregation nodes connected via a first type operation element, wherein a context-dependent operation of the first type operation element is based on past data of the speech training sample and is independent of future data of the speech training sample, and
constructing a speech recognition model based on the network search model, the speech recognition model being configured to process inputted streaming speech data comprising audio data including speech to obtain a speech recognition text corresponding to the streaming speech data.

11. The method according to claim 10, wherein
the speech recognition tag comprises acoustic recognition information of the speech sample, the acoustic recognition information comprising a phoneme, a syllable or a semi-syllable, and
the constructing the speech recognition model based on the network search model comprising:
constructing an acoustic model based on the network search model; the acoustic model being configured to process the streaming speech data to obtain acoustic recognition information about the streaming speech data, and
constructing the speech recognition model based on the acoustic model and a decoding graph.

12. A speech recognition apparatus, the apparatus comprising:
processing circuitry configured to
obtain a speech recognition model comprising a plurality of feature aggregation nodes connected via a first type operation element, wherein a context-dependent operation of the first type operation element is based on past speech data and is independent of future speech data;
receive streaming speech data, the speech data comprising audio data including speech;
process the streaming speech data via the speech recognition model to obtain a speech recognition text corresponding to the streaming speech data; and
output the speech recognition text.

13. The apparatus according to claim 12, wherein the processing circuitry is further configured to perform a neural architecture search on n unit networks comprising at least one first unit network comprising an input node, an output node, and at least one of the feature aggregation nodes connected by the first type operation element.

14. The apparatus according to claim 13, wherein the processing circuitry is further configured to perform the neural architecture search on the n unit networks connected via at least one of:
a double link mode, a single link mode, and a dense link mode.

15. The apparatus according to claim 13, wherein the processing circuitry is further configured to perform the neural architecture search on the n unit networks, including at least one second unit network comprising an input node, an output node and at least one of the feature aggregation nodes connected by a second type operation element, wherein the second type operation element is implemented using an operation dependent on the future speech data.

16. The apparatus according to claim 15, wherein the processing circuitry is further configured to perform the neural architecture search on
at least one of the first unit networks, each of the at least one of the first unit networks sharing a topology or sharing the topology and a network parameter, and
at least one of the second unit networks, each of the at least one of the second unit networks sharing a topology or sharing the topology and a network parameter.

17. The apparatus according to claim 12, wherein the processing circuitry is further configured to
obtain the speech recognition model comprising the first type operation element having a causality-based specified operation or a mask-based specified operation as the context-dependent operation that is independent of the future speech data is a causality-based specified operation or a mask-based specified operation.

18. The apparatus according to claim 12, wherein the processing circuitry is further configured to
obtain the speech recognition model comprising the feature aggregation nodes, which are configured to perform at least one of a summation operation, a concatenation operation, or a product operation on inputted data.

19. The apparatus according to claim 12, the processing circuitry is further configured to
obtain the speech recognition model comprising the first type operation element having at least one of a convolution operation, a pooling operation, an operation based on a long short-term memory artificial neural network (LSTM), or an operation based on a gated recurrent unit (GRU) as the context-dependent operation.

20. The apparatus according to claim 12, wherein
the speech recognition model comprises an acoustic model and a decoding graph, the acoustic model being based on a network search model obtained by performing a neural architecture search on an initial network via a speech training sample, and
the processing circuitry is further configured to:
process the streaming speech data via the acoustic model to obtain acoustic recognition information of the streaming speech data, the acoustic recognition information comprising a phoneme, a syllable, or a semi-syllable,
the speech recognition text being obtained by processing the acoustic recognition information of the streaming speech data via the decoding graph.
